(19) United States
(12) Patent Application Publication
(10) Pub. No.: US 2015/0178444 A1
(43) Pub. Date: Jun. 25, 2015

(54) METHOD AND DEVICE FOR DETERMINING HYDROPHOBIC ENERGY OF PROTEIN

(71) Applicant: Tsinghua University, Beijing (CN)

(72) Inventor: Weitao Sun, Beijing (CN)

(21) Appl. No.: 14/353,578

(22) PCT Filed: Jul. 23, 2013
(86) PCT No.: PCT/CN2013/079910

§ 371 Date: Apr. 23, 2014

(30) Foreign Application Priority Data
Oct. 25, 2012 (CN) 201210415104.X

(51) Int. Cl. G06F 19/16; G06F 19/12

(52) U.S. Cl. CPC G06F 19/16; G06F 19/12

(57) ABSTRACT

A method and a device for determining hydrophobic energy of protein are provided. The method for determining hydrophobic energy of the protein includes: based on space coordinates of the amino acids, determining distances of one amino acid to the remaining amino acids (S100); based on the distances, determining embedding coefficients of the amino acids (S200); and based on the embedding coefficients, determining the hydrophobic energy of the protein (S300).

### CROSS-REFERENCE TO RELATED APPLICATION

This application is a U.S. National Stage application under 35 U.S.C. §371 of International Application No. PCT/CN2013/07910, filed Jul. 23, 2013, which claims priority to and benefits of Chinese Patent Application Serial No. 201210415104.X, filed with the State Intellectual Property Office of P. R. China on Oct. 25, 2012, each of which is incorporated herein by reference in its entirety.

### FIELD

The present disclosure relates to molecular biology field, particularly relates to a method and a device for determining hydrophobic energy of protein. More particularly, the present disclosure relates to a method for simulating the folding of protein molecular structure on a computer, specially a method for calculating an energy of hydrophobic effect that drives protein molecules to fold.

### BACKGROUND

Protein is one of the most important macromolecular organic compounds for organisms' living and growth, and is the basis for every life activity. Currently, methods for detecting the structure of protein molecule include: X-ray scattering, nuclear magnetic resonance (NMR), cryo-electron microscopy. In recent years, the prediction and dynamic simulation of protein structure on a computer has become a research focus, with the development of theoretical model and calculating method.

Hydrophobic effect provides the main driving force for the folding of globular proteins in an aqueous solution environment, Kauzmann W. Some Factors in the Interpretation of Protein Denaturation. Advances in Protein Chemistry. 1959; 14:1-63; Tanford C. The Hydrophobic Effect: Formation of Micelles and Biological Membranes 2nd edition ed. New York: John Wiley & Sons Inc; 1980; Privalov P L. Stability of Protein-Structure and Hydrophobic Interactions. Biol Chem H-S. 1988; 369:199-; and Sun W. Protein folding simulation by all-atom CSAW method 2007, incorporated herein by reference. The process that the hydrophobic residues moving away from the solution environment leads to a rapid folding of the protein structure, which acts as the most important energy factor during the folding process of protein.

However, the present the method and device for determining hydrophobic energy of protein are still needed to be improved.

### SUMMARY

Embodiments of the present disclosure seek to solve at least one of the problems existing in the prior art. For this purpose, the present disclosure provides a method and a device for efficiently determining hydrophobic energy of protein.

Embodiments of a first broad aspect of the present disclosure provide a method for determining hydrophobic energy of protein, in which the protein may consist of a plurality of amino acids. According to embodiments of the present disclosure, the method may include: based on space coordinates of the amino acids, determining distances of one amino acid to the remaining amino acids; based on the distances, determining embedding coefficients of the amino acids; and based on the embedding coefficients, determining the hydrophobic energy of the protein. Therefore, with the method according to embodiments of the present disclosure, hydrophobic energy of the protein may be determined efficiently, which further may be of great importance for improving the efficiency and accuracy for predicting the folding and the structure of the protein.

According to some embodiments of the present disclosure, the above method for determining hydrophobic energy of the protein may have the following additional features.

In some embodiments of the present disclosure, the determining embedding coefficients of the amino acids may include: based on the distances, determining residue neighboring relationships of the one amino acid, and based on the number of neighboring amino acids of the one amino acid, determining the embedding coefficient of the one amino acid. Therefore, with the method according to embodiments of the present disclosure, an embedding degree of the amino acid residue may be analyzed efficiently and rapidly, further a size change degree of the hydrophobic group may be determined efficiently. Thereby, infiltration effect may be estimated efficiently, and the hydrophobic energy may be determined efficiently.

According to an embodiment of the present disclosure, the determining residue neighboring relationships of the amino acids may be performed by a principle of: a residue A and a residue B are contacted with each other and are neighbors if

rᵢⱼ^{AB}<rᵢ+rⱼ+d^{AB}

in which i^{AB}ᵢⱼ is a distance between an atom i in the residue A and an atom j in the residue B, d^{AB} is an action distance of Van der Waals' force between surfaces of the residue A and the residue B, and d^{AB} is 5 Å,
an action distance of Van der Waals' force between surfaces of the residue A and the residue B, and d^{AB} is 5 Å, rᵢ is a radius of the atom i, and rⱼ is a radius of the atom j.

Therefore, with the method according to embodiments of the present disclosure, distances of one amino acid to the remaining amino acids may be efficiently determined based on space coordinates of the amino acids, further the embedding degree of the amino acid residue may be analyzed efficiently and rapidly, and then the size change degree of the hydrophobic group may be determined efficiently.

According to an embodiment of the present disclosure, the embedding coefficient c of the amino acid is determined in accordance with the following equation:

$$c = \frac{{n}_{c}}{q}$$

in which n_{c} is the number of neighbors contacted with the amino acid, and q is the largest number of neighbors acceptable to a surrounding space of the amino acid, and q ranges from 3 to 6.

Therefore, with the method according to embodiments of the present disclosure, the embedding degree of the amino acid residue may be analyzed efficiently and rapidly, further the size change degree of the hydrophobic group may be determined efficiently, and then the infiltration effect may be estimated efficiently and the hydrophobic energy may be determined efficiently.

According to an embodiment of the present disclosure, the determining the hydrophobic energy of the protein may include: determining a hydrophobic intensity factor p of the amino acid based on the embedding coefficient c, and the hydrophobic intensity factor p is determined in accordance with the following equation:

$$p = 1 - \frac{1}{1 + {exp}^{- ( C - 1 )}}$$

An energy decrease dE_{A} of hydrophobic groups of the amino acid may be calculated in accordance with the following equation:

$${dE}_{A} = p {\sum }_{n = 1}^{{n}_{c}} {dE}_{An}$$

in which n_{c} is the number of neighbors contacted with the amino acid, and dE_{An} is the hydrophobic energy resulting from an aggregation of the amino acid and the nth residue.

Therefore, with the method according to embodiments of the present disclosure, the size change degree of the hydrophobic group may be determined efficiently, further the infiltration effect may be estimated efficiently, and then the hydrophobic energy may be determined efficiently.

Embodiments of a second broad aspect of the present disclosure provide a device for determining hydrophobic energy of protein, in which the protein may consist of a plurality of amino acids. According to some embodiments of the present disclosure, the device may be operated with the method for determining hydrophobic energy of protein described above. Therefore, with the device according to embodiments of the present disclosure, hydrophobic energy of the protein may be determined efficiently, which further may be of great importance for improving the efficiency and accuracy for predicting the folding and the structure of the protein.

According to some embodiments of the present disclosure, the device may include: a distance calculating unit configured to determine distances of one amino acid to the remaining amino acids based on space coordinates of the one amino acids; an embedding coefficient calculating unit connected to the distance calculating unit and configured to determine embedding coefficients of the amino acids based on the distances; and a hydrophobic energy calculating unit connected to the embedding coefficient calculating unit and configured to determine the hydrophobic energy of the protein based on the embedding coefficients. Therefore, with the device according to embodiments of the present disclosure, hydrophobic energy of the protein may be determined efficiently, which further may be of great importance for improving the efficiency and accuracy for predicting the folding and structure of the protein.

According to some embodiments of the present disclosure, the above device for determining hydrophobic energy of protein may have the following additional features.

According to an embodiment of the present disclosure, the embedding coefficient calculating unit may include: a residue neighboring relationship determining module configured to determine neighboring relationships of the amino acids based on the distances, and an embedding coefficient determining module connected to the residue neighboring relationship determining module and configured to determine the embedding coefficient of the one amino acid based on the number of neighboring amino acids of the one amino acid. Therefore, with the device according to embodiments of the present disclosure, distances of one amino acid to the remaining amino acids may be efficiently determined based on space coordinates of the amino acids, further an embedding degree of the amino acid residue may be analyzed efficiently and rapidly. At the same time, the embedding degree of the amino acid residue may be decided quantitatively. In this way, a size change degree of the hydrophobic group may be determined efficiently, further infiltration effect may be estimated efficiently, and then the hydrophobic energy may be determined efficiently.

According to an embodiment of the present disclosure, the residue neighboring relationship determining module may be configured to determine the neighboring relationship of the amino acid by a principle of: a residue A and a residue B are contacted with each other and are neighbors if

rᵢⱼ^{AB}<rᵢ+rⱼ+d^{AB}

in which r^{AB}ᵢⱼ is a distance between an atom i in the residue A and an atom j in the residue B, d^{AB} is an action distance of Van der Waals' force between surfaces of the residue A and the residue B, and d^{AB} is 5 Å, rᵢ is a radius of the atom i, and rⱼ is a radius of the atom j.

Therefore, with the method according to embodiments of the present disclosure, distances of one amino acid to the remaining amino acids may be efficiently determined based on space coordinates of the amino acids, further the embedding degree of the amino acid residue may be analyzed efficiently and rapidly, and then the size change degree of the hydrophobic group may be determined efficiently.

According to an embodiment of the present disclosure, the embedding coefficient determining module may be configured to determine the embedding coefficient c in accordance with the following equation:

$$c = \frac{{n}_{c}}{q}$$

in which n_{c} is the number of neighbors contacted with the amino acid, and q is the largest number of neighbors acceptable to a surrounding space of the amino acid, and q ranges from 3 to 6.

Therefore, with the method according to embodiments of the present disclosure, the embedding degree of the amino acid residue may be analyzed efficiently and rapidly, further the size change degree of the hydrophobic group may be determined efficiently, and then the infiltration effect may be estimated efficiently and the hydrophobic energy may be determined efficiently.

The method for determining hydrophobic energy of protein according to embodiments of the present disclosure may have at least one of the following advantages.

1) With the method for determining hydrophobic energy of protein according to embodiments of the present disclosure, the hydrophobic effect may be adjusted automatically in accordance with a state of the structure of the protein molecule. The method may be capable of simulating the folding of the protein molecule and calculating an energy contribution of hydrophobic effect performed on the stability of the protein structure, based on the state of the amino acid groups and a relative intensity between the naturally formed hydrophobic effect and the hydrogen bond effect.

2) With the method for determining hydrophobic energy of protein according to embodiments of the present disclosure, the flexibility of the protein structure may be improved. Driving intensity from the hydrophobic effect and applied on a collapse of the protein structure may be adjusted according to the tightness of the protein structure. That is to say, when the protein structure is overtight, the protein structure may be allowed to open so that misfolding may be avoided. In this way, folding of the protein molecule may be facilitated.

3) With the method for determining hydrophobic energy of protein according to embodiments of the present disclosure, a self-adapting hydrophobic energy-hydrogen bond energy balance mechanism may be provided, which facilitates to the adjustable balance between the hydrophobic core and a substructure. In this way, the flexibility of the protein structure may be improved. In addition, it facilitates to form more hydrogen bonds, substructures and tertiary structures of proteins.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a flow chart showing a method for determining hydrophobic energy of protein according to an embodiment of the present disclosure;

FIG. 2 is a schematic view showing a device for determining hydrophobic energy of protein according to an embodiment of the present disclosure;

FIG. 3 is a schematic view showing a device for determining hydrophobic energy of protein according to another embodiment of the present disclosure;

FIG. 4 is a schematic view showing a simulated molecular structure of a myoglobin (crystal structure No. 2BLH) in an initial unfolding state in the three dimensions according to an embodiment of the present disclosure;

FIG. 5 is a schematic view showing an X-ray structure of a myoglobin (crystal structure No. 2BLH) according to an embodiment of the present disclosure;

FIG. 6 is a curve showing the relationship between a rotation radius and a deinfiltration factor under a non-deinfiltration condition according to an embodiment of the present disclosure;

FIG. 7 shows a curve showing the relationship between the rotation radius and the deinfiltration factor under a deinfiltration condition according to an embodiment of the present disclosure;

FIG. 8 is a curve showing the relationship between the hydrophobic-hydrogen bond energy and the number of the hydrogen bonds under a non-deinfiltration condition according to an embodiment of the present disclosure; and

FIG. 9 is a curve showing the relationship between the hydrophobic-hydrogen bond energy and the number of the hydrogen bonds under a deinfiltration condition according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the description, unless specified or limited otherwise, it is to be understood that phraseology and terminology used herein with reference to device or element orientation (for example, terms like “thickness”, “upper”, “lower”, and the like) should be construed to refer to the orientation as then described or as shown in the drawings under discussion for simplifying the description of the present disclosure, but do not alone indicate or imply that the device or element referred to must have a particular orientation. Moreover, it is not required that the present disclosure is constructed or operated in a particular orientation.

It is known that hydrophobic effect is the main driving force for the folding of spheroprotein in an aqueous solution environment. The energy contribution on the folding of protein is related with a state of the protein structure, while the coordination and the balance between the hydrophobic effect and the hydrogen bond effect play a key role in the folding of protein structure, which at the same time are the difficulties for simulating the folding of protein structure on the computer. During the research process, the inventors have found that under a deinfiltration condition, it is hard to adjust a relative intensity between the hydrophobic effect and the hydrogen bond effect, which may be expressed as follows.

1) When parameters are provided so that the hydrophobic effect is stronger than the hydrogen bond effect, the hydrophobic effect plays a leading role to the free energy. The structure of protein molecule may be compressed into a spherical structure. The spherical structure is hard to open so that distances between residues are hard to be adjusted, which prevents the formation of hydrogen bonds. What is worse, it leads to the formation of random coils.

2) When parameters are provided so that the hydrophobic effect is weaker than the hydrogen bond effect, the hydrogen bond effect plays a leading role to the free energy. In this condition, the structure of protein molecule is so flexible that distances between residues may be adjusted, which facilitates the formation of hydrogen bonds and regular structures. However, hydrophobic cores are hardly formed. In addition, the structure of the protein molecule is so loose that regular structure may not be opened either. Therefore, stable structures cannot be formed.

3) It is extremely hard to find a reasonable method for calculating hydrophobic energy, in which both hydrophobic effect and hydrogen bond effect contribute to the formation of substructure and tertiary structure during the whole folding process.

Based on the above reasons, it is difficult to determine the hydrophobic energy of protein under a deinfiltration effect condition.

The inventors has surprisingly found that, under the deinfiltration effect condition, the relative intensity between the hydrophobic effect and hydrogen bond effect may be well adjusted with the method and device according to embodiments of the present disclosure. Specific details will be described as follows.

1) With the method and device according to embodiments of the present disclosure, the structure of protein molecule may unfold when it is overtight, thus avoiding the problem of misfolding and accelerating the folding of the structure of protein molecule. The flexibility of protein structure may be improved. Thereby the following problems normally occurred in a conventional method or device may be solved: the model for the intensity of hydrophobic effect is fixed, and the protein structure is neither overtight so that the number of hydrogen bonds is not enough, nor overloose so that hydrophobic core cannot be formed.

2) With the method and device according to embodiments of the present disclosure, a self-adapting hydrophobic-hydrogen bond energy balance mechanism may be formed, which facilitates to the coordination and balance between the hydrophobic core and the substructure. The flexibility for adjusting the protein structure may be improved, which facilitates to form more hydrogen bonds and substructures. Therefore, the formation of hydrogen bonds and substructures may be improved during the folding process of the protein.

Based on the above concerns, the inventors proposed the method for determining hydrophobic energy of protein. According to the method in some embodiments of the present disclosure, firstly distances of one amino acid to the remaining amino acids are determined based on space coordinates of the one amino acids; embedding coefficients of the amino acids are determined based on the distances; and then size change degrees of the hydrophobic groups may be determined according to the embedding coefficients; then the infiltration effect may be estimated according to the size change degree of the hydrophobic groups; and finally the hydrophobic energy of the protein may be determined based on the estimation of the infiltration effect.

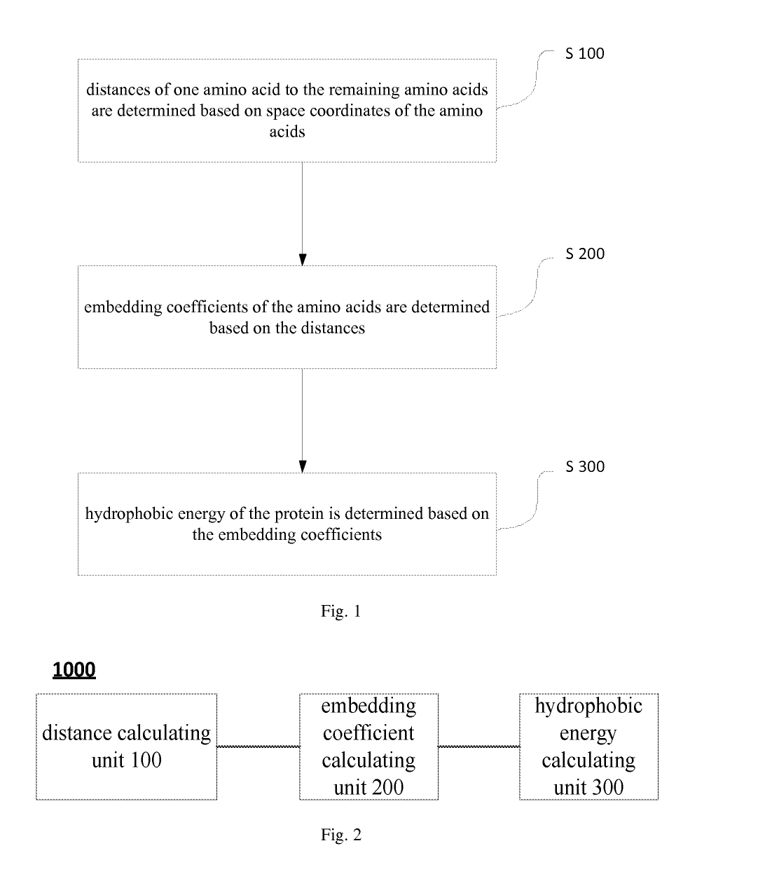

According to an aspect of the present disclosure, a method for determining hydrophobic energy of protein may be provided. Referring to FIG. 1, the method according to embodiments of the present disclosure may include the following steps S100-S300.

In the step S100, distances of one amino acid to the remaining amino acids are determined based on space coordinates of the amino acids.

In this step, based on space coordinates of the amino acids, distances of one amino acid to the remaining amino acids may be determined. Thereby, relationships between the distances may be determined.

In some embodiments of the present disclosure, the determining embedding coefficients of the amino acids may include: based on the distances, determining residue neighboring relationships of the one amino acid; and based on the number of neighboring amino acids of the one amino acid, determining the embedding coefficient of the one amino acid.

In some embodiments of the present disclosure, the determining residue neighboring relationships of the one amino acids is performed by a principle of: a residue A and a residue B are contacted with each other and are neighbors if

rᵢⱼ^{AB}<rᵢ+rⱼ+d^{AB}

in which r^{AB}ᵢⱼ is a distance between an atom i in the residue A and an atom j in the residue B, d^{AB} is an action distance of Van der Waals' force between surfaces of the residue A and the residue B, and d^{AB} is 5 Å, rᵢ is a radius of the atom i, and rⱼ is a radius of the atom j.

Therefore, the contacting relationship of one amino acid to another amino acid may be efficiently determined based on space coordinates of the amino acids, further the embedding degree of the amino acid residue may be analyzed efficiently and rapidly using space analyzing method, and then the size change degree of the hydrophobic group may be determined efficiently.

According to embodiments of the present disclosure, the contacting relationship between two amino acids may be stored by the Hash Table. The contacting relationship between amino acids, for example, the neighboring relationship, is a base for determining the embedding degree. Generally, it is required for a n×n sparse matrix for storing the contacting relationship. However, when n is a rather large value, it needs to take a very large memory space to store the contacting relationship. The inventors have found that, the Hash Table may be used to store the neighboring relationship between residues. In one embodiment, a residue number is input as a Hash function in order to generate a Hash value. In this way, memory space required for simulation calculating the folding of protein structure may be significantly reduced. Thereby, the contacting relationship between amino acids may be stored by the Hash Table efficiently.

In the step S200, embedding coefficients of the amino acids are determined based on the distances.

In this step, based on distances obtained in the step S100, embedding coefficients of the amino acids may be determined. Thereby, embedding degrees of amino acid residues may be determined.

In some embodiments of the present disclosure, the embedding coefficient c of the amino acid is determined in accordance with the following equation:

$$c = \frac{{n}_{c}}{q}$$

in which n_{c} is the number of neighbors contacted with the amino acid, and q is the largest number of neighbors acceptable to a surrounding space of the amino acid, and q ranges from 3 to 6.

Therefore, the embedding degree of the amino acid residue may be quantitatively estimated. Further, the size change degree of the hydrophobic group may be determined, and then the infiltration effect may be estimated efficiently and the hydrophobic energy may be determined efficiently.

In the step S300, the hydrophobic energy of the protein is determined based on the embedding coefficients.

In this step, size change degree of the hydrophobic group may be determined based on the embedding coefficients obtained in the step S200, then the infiltration effect may be estimated based on the size change degree, and then the hydrophobic energy of the protein may be determined based on the infiltration effect. Thereby, the hydrophobic effect of the protein may be determined.

The relationship between the size of the hydrophobic group and the infiltration effect may be described in the following.

The interaction intensity between the water molecule and the protein residue may depend on the size of the hydrophobic group. The larger the hydrophobic group is, the harder the water molecule is capable of enclosing the hydrophobic group tightly. In turn, the smaller the hydrophobic group is, the easier the water molecule is capable of enclosing the hydrophobic group. The infiltration effect is caused by the interaction between the protein molecule and the water molecule. A large hydrophobic group may be surrounded by a small amount of water molecules, thus the intensity of the hydrophobic effect may be reduced, and the infiltration effect is apparent. On the contrary, a small hydrophobic group may be surrounded by a large amount of water molecules, thus the intensity of the hydrophobic effect may be increased, and the infiltration effect is not apparent.

In some embodiments of the present disclosure, hydrophobic intensity factor p associated with the embedding coefficient c is introduced. The hydrophobic intensity factor p may be used to describe the specific intensity of the hydrophobic effect. The hydrophobic intensity factor p describes the energy contribution generated from the aggregation of the hydrophobic residue and applied on the stability of protein molecular structure, in which the hydrophobic group may be formed by the amino acid residue and the adjacent residue. The larger the embedding coefficient c is, the smaller the p is. Accordingly the infiltration effect is more apparent, and further the energy contribution that the hydrophobic effect made on the stability of the protein structure is weak. On the contrary, the smaller the embedding coefficient c is, the larger the p is. Accordingly the infiltration effect is not apparent, and further the energy contribution that the hydrophobic effect made on the stability of the protein structure is strong. Thereby, the hydrophobic energy may be determined efficiently based on estimation on the infiltration effect.

In some embodiments of the present disclosure, the hydrophobic intensity factor p is determined in accordance with the following equation:

$$p = 1 - \frac{1}{1 + {exp}^{- ( C - 1 )}}$$

Thereby, the size change degree of the hydrophobic group may be determined and the infiltration effect may be estimated efficiently, thereby the hydrophobic energy of the protein may be determined efficiently.

In some embodiments of the present disclosure, the hydrophobic energy may be determined based on the infiltration effect. Provided that a residue A is surrounded by n_{c} neighbors which separate the residue A from the water solution and a hydrophobic energy decrease resulted from the aggregation of the residue and the nth residue is described by dE_{An}, the energy decrease brought by the whole hydrophobic group containing the residue A may be expressed as follows:

$${dE}_{A} = p {\sum }_{n = 1}^{{n}_{c}} {dE}_{An}$$

in which n_{c} is the number of neighbors contacted with the amino acid, and dE_{An} is the hydrophobic energy resulting from an aggregation of the amino acid and the nth residue.

As described above, the hydrophobic energy of the protein may be obtained from the sum of hydrophobic energy of each hydrophobic group. Thereby, with the method according to embodiments of the present disclosure, the hydrophobic energy of the protein may be determined efficiently.

According to a second aspect of embodiments of the present disclosure, a device for determining hydrophobic energy of protein is provided, in which the protein is consisting of a plurality of amino acids.

As shown in FIG. 2, in an embodiment of the present disclosure, the device 1000 may include a distance calculating unit 100, an embedding coefficient calculating unit 200 and a hydrophobic energy calculating unit 300.

In some embodiments of the present disclosure, the distance calculating unit 100 may be configured to determine distances of one amino acid to the remaining amino acids based on space coordinates of the amino acids. The embedding coefficient calculating unit 200 may be connected to the distance calculating unit 100 and configured to determine embedding coefficients of the amino acids based on the distances. The hydrophobic energy calculating unit 300 may be connected to the embedding coefficient calculating unit 200 and configured to determine the hydrophobic energy of the protein based on the embedding coefficients.

The device according to embodiments of the present disclosure may be operated with the method for determining the hydrophobic energy of protein described above, therefore the hydrophobic energy of the protein may be determined efficiently.

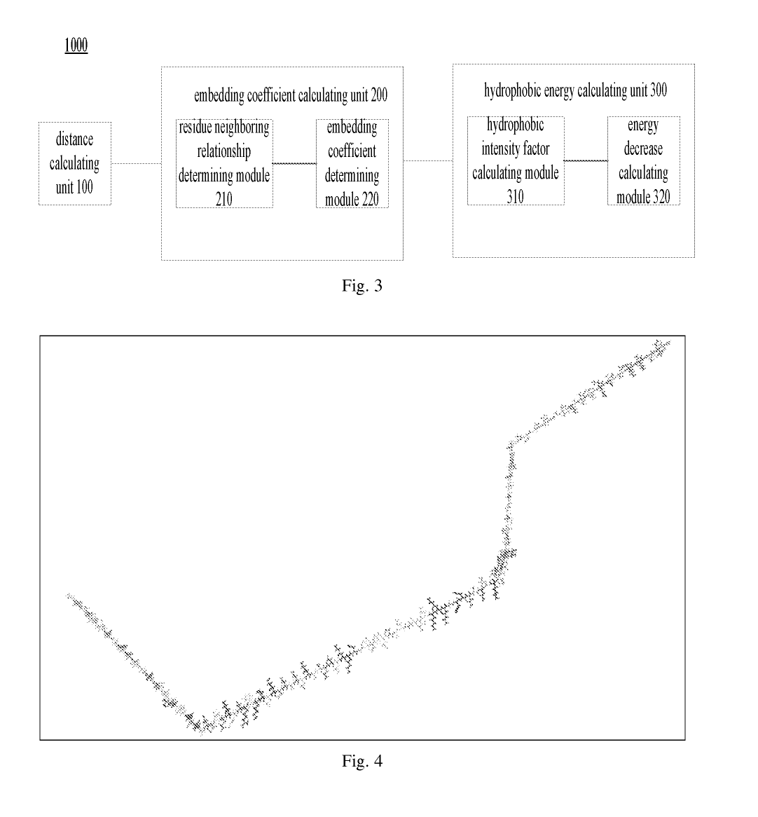

As shown in FIG. 3, in an embodiment of the present disclosure, the embedding coefficient calculating unit 200 may include a residue neighboring relationship determining module 210 and an embedding coefficient determining module 220.

In some embodiments of the present disclosure, the residue neighboring relationship determining module 210 may be configured to determine neighboring relationships of the amino acids based on the distances. The embedding coefficient determining module 220 may be connected to the residue neighboring relationship determining module 210 and configured to determine the embedding coefficient of the one amino acid based on the number of neighboring amino acids of the one amino acid.

In some embodiments of the present disclosure, the neighboring relationship determining module 210 may be configured to determine the neighboring relationship of the amino acid by a principle of: a residue A and a residue B are contacted with each other and are neighbors if

rᵢⱼ^{AB}<rᵢ+rⱼ+d^{AB}

in which r^{AB}ᵢⱼ is a distance between an atom i in the residue A and an atom j in the residue B, d^{AB} is an action distance of Van der Waals' force between surfaces of the residue A and the residue B, and d^{AB} is 5 Å, rᵢ is a radius of the atom i, and Rⱼ is a radius of the atom j.

Therefore, the contacting relationship of one amino acid to another amino acid may be efficiently determined based on space coordinates of the amino acids, further the embedding degree of the amino acid residue may be analyzed efficiently and rapidly using space analyzing method, and then the size change degree of the hydrophobic group may be determined efficiently.

According to an embodiment of the present disclosure, the embedding coefficient determining module 220 may be configured to determine the embedding coefficient c in accordance with the following equation:

$$c = \frac{{n}_{c}}{q}$$

in which n_{c} is the number of neighbors contacted with the amino acid, and q is the largest number of neighbors acceptable to a surrounding space of the amino acid, and q ranges from 3 to 6.

Therefore, the embedding degree of the amino acid residue may be analyzed efficiently and rapidly, further the size change degree of the hydrophobic group may be determined efficiently, and then the infiltration effect may be estimated efficiently and the hydrophobic energy may be determined efficiently.

In some embodiments of the present disclosure, the hydrophobic energy calculating unit 300 may include a hydrophobic intensity factor calculating module 310 and an energy decrease calculating module 320. The hydrophobic intensity factor calculating module 310 may be configured to calculate a hydrophobic intensity factor p of the amino acid based on the embedding coefficient c, and the hydrophobic intensity factor p is determined in accordance with the following equation:

$$p = 1 - \frac{1}{1 + {exp}^{- ( C - 1 )}}$$

The energy decrease calculating module 320 may be connected to the hydrophobic intensity factor calculating module and configured to calculate an energy decrease dE_{A} of hydrophobic groups of the amino acid in accordance with the following equation:

$${dE}_{A} = p {\sum }_{n = 1}^{{n}_{c}} {dE}_{An}$$

in which n_{c} is a number of neighbors contacted with the amino acid, and dE_{An} is the hydrophobic energy resulted from an aggregation of the amino acid and an nth residue.

As described above, the hydrophobic energy of the protein may be obtained from the sum of the hydrophobic energy of each hydrophobic group. Thereby, with the device according to embodiments of the present disclosure, the size change degree of the hydrophobic group may be determined efficiently and the infiltration effect may be estimated efficiently, and then the hydrophobic energy of the protein may be determined efficiently.

According to some embodiments of the present disclosure, the types of the proteins to be detected are not particularly limited. For example, in some embodiments, myoglobin may be detected. Those with ordinary skill in the art may appreciate that, other types of proteins may be detected, without particular limits in the present disclosure. Thus, details of other types of proteins and testing methods are omitted herein, which are incorporated in the present disclosure by reference.

According to some embodiments of the present disclosure, there are no particular limits for the specific condition for determining the hydrophobic energy of the protein. In an embodiment of the present disclosure, the hydrophobic energy may be determined by an all atom CSAW folding calculating method. In another embodiment of the present disclosure, the hydrophobic energy may be detected in the beginning of the folding (for example, prior to the 70^{th} step). Those with ordinary skill in the art may appreciate that, any conventional method and device may be applied to perform the method according to embodiments of the present disclosure. Further, process parameters required in the method and device according to embodiments of the present disclosure may be determined by a prior experiment, which is known to the person skilled in the art, thus related details are omitted herein.

With the method and device according to embodiments of the present disclosure, efficiency and the accuracy for estimating the folding and structure of the protein may be improved. The device and method may be applied in other fields, which is known to the person skilled in the art, thus related details are omitted herein but fall in the scope of the present disclosure.

Reference will be made in detail to embodiments of the present disclosure. The embodiments described herein are explanatory, illustrative, and used to generally understand the present disclosure. The embodiments shall not be construed to limit the present disclosure.

In addition, unless expressly described otherwise, the apparatus and materials used in the following embodiments are all commercially available.

According to the following embodiments, the method for determining the hydrophobic energy of the protein may include the following steps:

Step 1) distances of one amino acid to the remaining amino acids are determined, and a contacting relationship between the amino acids are stored in the Hash Table;

Step 2) the embedding degree of the residue is quantitatively estimated by the normalization of the residue space stacking model;

Step 3) the size of the hydrophobic group is estimated based on the embedding degree of the residue, and then the hydrophobic intensity factor is determined based on the infiltration effect; and

Step 4) a sum of the hydrophobic energy of all hydrophobic groups is calculated, then the hydrophobic energy of the protein is obtained.

### Embodiment 1

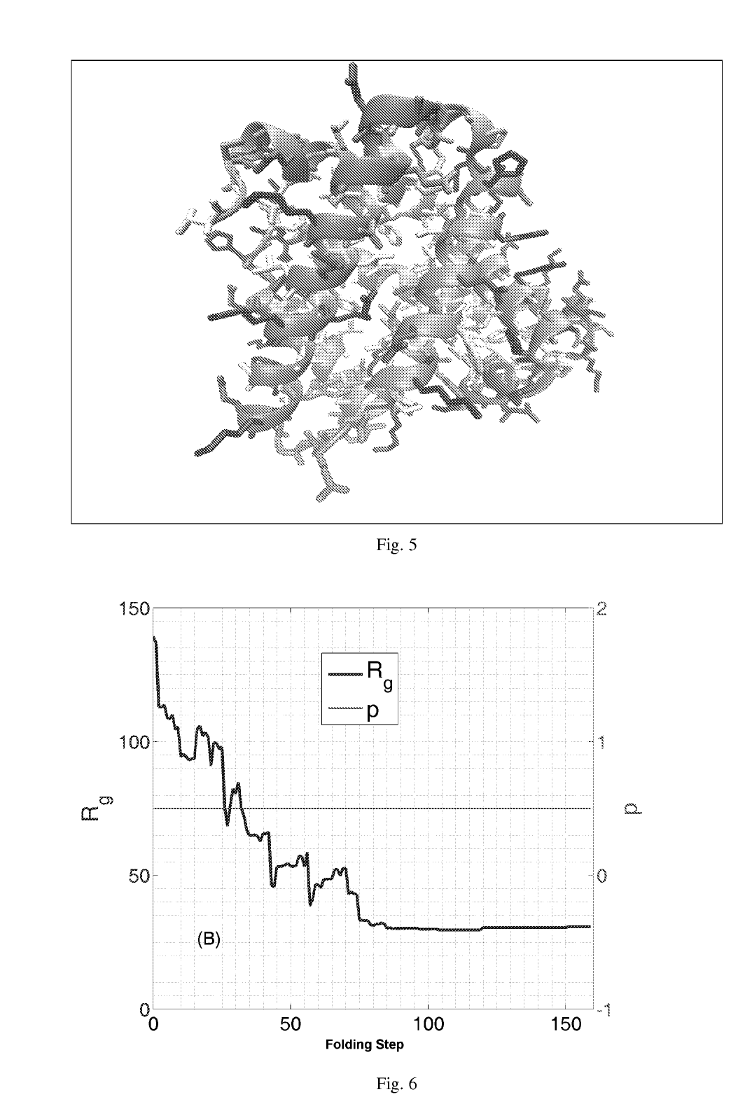

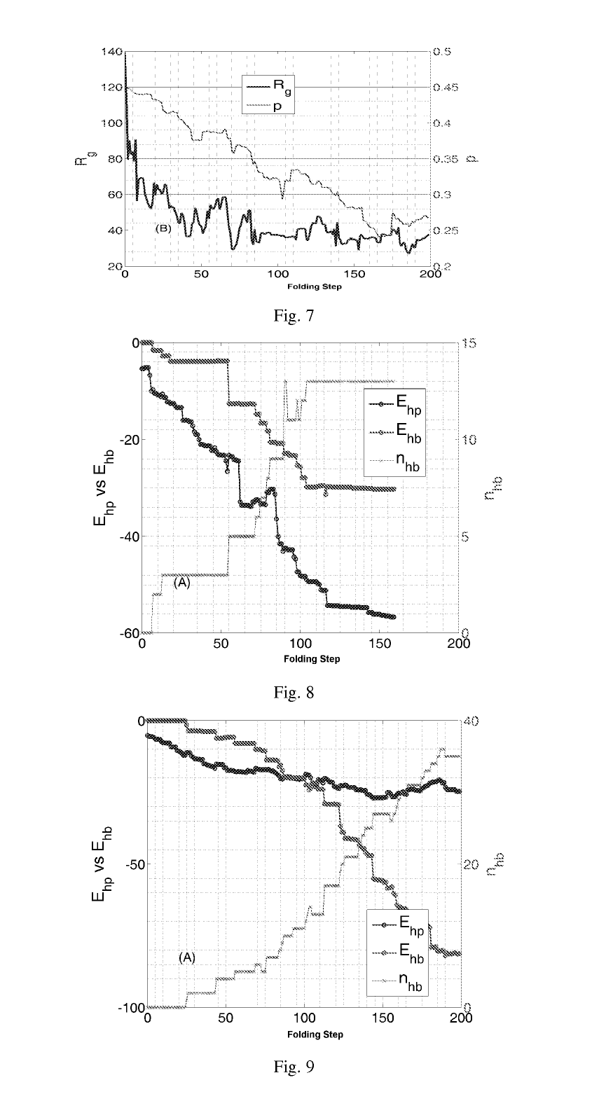

According to the method described above, the myoglobin (crystal structure No. 2BLH) was detected by an all atom CSAW folding calculating method, and the structure of the myoglobin was shown in FIGS. 4-5. After the hydrophobic collapse stage in the beginning of the folding, as shown in FIG. 7, the rotation radius of the protein molecule was fluctuated up and down with the change of the folding steps, which indicated that the protein was still capable of adjusting its structure. However, the hydrophobic intensity factor p reduced with the reduction of the radius of the structure, which indicated that the hydrophobic effect may be weakened due to the deinfiltration effect when the structure of the protein molecule was folded overtightly. In this condition, the protein structure had more chance for adjusting partially. In comparison with a curve (shown in FIG. 6) not applying a deinfiltration hydrophobic effect, the hydrophobic intensity factor p was not changing with the state of the protein structure. The curve illustrating the ration radius of the protein molecule tended to be a flat line after the collapse stage, which indicated that the structure of the protein molecule was always constrained by a strong hydrophobic effect, and the structure was not capable of unfolding to perform a partial adjustment.

With a conventional fixed hydrophobic effect model, the structure was neither too tight so that the number of hydrogen bonds were not enough, nor too loose so that hydrophobic cores cannot be formed. With the method according to embodiments of the present disclosure, the driving intensity of the hydrophobic effect performed on the collapse of the structure may be adjusted continuously according to the tightness of the protein structure. In this way, the protein structure may be unfolded when it is too right, which avoids the problem of misfolding and facilitates the acceleration of the folding of the protein molecules. Thereby, the method according embodiments of the present disclosure may improve the flexibility of the structure of the protein molecule.

### Embodiment 2

According to the method described above, the myoglobin (crystal structure No. 2BLH) was detected by an all atom CSAW folding calculating method. As shown in FIG. 9, in the beginning of the folding (before the 70^{th} step), the hydrophobic effect played a leading role. The energy of the hydrophobic effect was lower than the energy of the hydrogen bond, which lead the structure of the protein to change in order to facilitate the decrease of the hydrophobic energy. After that, the radius of the structure was decreased to a stable value. In the present embodiment, it is advantageous to use the calculating technique for the hydrophobic energy that considers the deinfiltration effect. Due to the deinfiltration effect, the intensity of the hydrophobic effect was reduced, the guidance of the hydrophobic energy on the folding of the structure was weakened, and the hydrogen energy was more important. The two energy curves were crossed around the 90^{th} step. After that, the energy of the hydrogen bond was lower than the hydrophobic energy, which lead the structure to change in order to facilitate the formation of more hydrogen bonds. The increase of hydrogen bonds may facilitate the folding of the protein structure. In comparison with a curve (as shown in FIG. 8) not applying the deinfiltration hydrophobic effect calculating technique, due to the non-infiltration effect, the hydrophobic energy was always smaller than the energy of the hydrogen bond. In this condition, the protein structure always changed in order to facilitate the decrease of the hydrophobic energy, thus preventing the formation of more hydrogen bonds. After the 100^{th} step, the number of hydrogen bonds stopped from increasing and remained 13.

With the method disclosed in the present embodiment, the flexibility of the structure of the protein molecule is improved, and the formation of the hydrogen bond and the acceleration of the folding of protein structure are both improved. It can be concluded that, the method according to embodiments of the present disclosure may facilitate the formation of hydrogen bond and the substructure.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present disclosure, and changes, alternatives, and modifications can be made in the embodiments without departing from spirit, principles and scope of the present disclosure.

What is claimed is:

1. A method for determining hydrophobic energy of protein, wherein the protein consists of a plurality of amino acids, and the method comprises:
based on space coordinates of the amino acids, determining distances of one amino acid to the remaining amino acids;
based on the distances, determining embedding coefficients of the amino acids; and
based on the embedding coefficients, determining the hydrophobic energy of the protein.

2. The method according to claim 1, wherein the determining embedding coefficients of the amino acids comprises:
based on the distances, determining residue neighboring relationships of the one amino acid, and
based on the number of neighboring amino acids of the one amino acid, determining the embedding coefficient of the one amino acid.

3. The method according to claim 2, wherein the determining residue neighboring relationships of the amino acids is performed by a principle of:
a residue A and a residue B are contacted with each other and are neighbors if
rᵢⱼ^{AB}<rᵢ+rⱼ+d^{AB}
wherein
r^{AB}ᵢⱼ is a distance between an atom i in the residue A and an atom j in the residue B,
d^{AB} is an action distance of Van der Waals' force between surfaces of the residue A and the residue B, and d^{AB} is 5 Å,
rᵢ is a radius of the atom i, and
rⱼ is a radius of the atom j.

4. The method according to claim 2, wherein the embedding coefficient c of the amino acid is determined in accordance with the following equation:
$$c = \frac{{n}_{c}}{q}$$
wherein
n_{c} is the number of neighbors contacted with the amino acid, and
q is the largest number of neighbors acceptable to a surrounding space of the amino acid, and q ranges from 3 to 6.

5. The method according to claim 4, wherein the determining the hydrophobic energy of the protein comprises:
determining a hydrophobic intensity factor p of the amino acid based on the embedding coefficient c, and the hydrophobic intensity factor p is determined in accordance with the following equation:
$$p = 1 - \frac{1}{1 + {exp}^{- ( C - 1 )}}$$
and
calculating an energy decrease dE_{A} of hydrophobic groups of the amino acid in accordance with the following equation:
$${dE}_{A} = p {\sum }_{n = 1}^{{n}_{c}} {dE}_{An}$$
wherein
n_{c} is the number of neighbors contacted with the amino acid, and
dE_{An} is the hydrophobic energy resulting from an aggregation of the amino acid and the nth residue.

6. A device for determining hydrophobic energy of protein, wherein the protein consists of a plurality of amino acids, and the device comprises:
a distance calculating unit configured to determine distances of one amino acid to the remaining amino acids based on space coordinates of the amino acids;
an embedding coefficient calculating unit connected to the distance calculating unit and configured to determine embedding coefficients of the amino acids based on the distances; and
a hydrophobic energy calculating unit connected to the embedding coefficient calculating unit and configured to determine the hydrophobic energy of the protein based on the embedding coefficients.

7. The device according to claim 6, wherein the embedding coefficient calculating unit comprises:
a residue neighboring relationship determining module configured to determine neighboring relationships of the amino acids based on the distances, and
an embedding coefficient determining module connected to the residue neighboring relationship determining module and configured to determine the embedding coefficient of the one amino acid based on the number of neighboring amino acids of the amino acid.

8. The device according to claim 7, wherein the residue neighboring relationship determining module is configured to determine the neighboring relationship of the amino acid by a principle of:
a residue A and a residue B are contacted with each other and are neighbors if
rᵢⱼ^{AB}<rᵢ+rⱼ+d^{AB}
wherein
r^{AB}ᵢⱼ is a distance between an atom i in the residue A and an atom j in the residue B,
d^{AB} is an action distance of Van der Waals' force between surfaces of the residue A and the residue B, and d^{AB} is 5 Å,
rᵢ is a radius of the atom i, and
rⱼ is a radius of the atom j.

9. The device according to claim 7, wherein the embedding coefficient determining module is configured to determine the embedding coefficient c in accordance with the following equation:
$$c = \frac{{n}_{c}}{q}$$
wherein
n_{c} is the number of neighbors contacted with the amino acid, and
q is the largest number of neighbors acceptable to a surrounding space of the amino acid, and q ranges from 3 to 6.

10. The device according to claim 7, wherein the hydrophobic energy calculating unit comprises:
a hydrophobic intensity factor calculating module configured to calculate a hydrophobic intensity factor p of the amino acid based on the embedding coefficient c, and the hydrophobic intensity factor p is determined in accordance with the following equation:
$$p = 1 - \frac{1}{1 + {exp}^{- ( C - 1 )}}$$
and
an energy decrease calculating module connected to the hydrophobic intensity factor calculating module and configured to calculate an energy decrease dE_{A} of hydrophobic groups of the amino acid in accordance with the following equation:
$${dE}_{A} = p {\sum }_{n = 1}^{{n}_{c}} {dE}_{An}$$
wherein
n_{c} is a number of neighbors contacted with the amino acid, and
dE_{An} is the hydrophobic energy resulted from an aggregation of the amino acid and an nth residue.
